(19) United States
(12) Patent Application Publication
(10) Pub. No.: US 2017/0248818 A1
(43) Pub. Date: Aug. 31, 2017

(54) DISPLAY DEVICE, REFLECTIVE DISPLAY PANEL AND REFLECTIVE UNIT OF THE SAME

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 14/902,431

(22) PCT Filed: Dec. 25, 2015
(86) PCT No.: PCT/CN2015/098962

§ 371 Date: Dec. 31, 2015

(30) Foreign Application Priority Data
Dec. 4, 2015 (CN) 201510890112.3

(51) Int. Cl. G02F 1/1335

(52) U.S. Cl. CPC G02F 1/133553; G02F 1/133504; G02F 2001/133616

(57) ABSTRACT

A display device, a reflective display panel and a reflective unit are provided. The reflective display panel includes an upper substrate unit, a lower substrate unit, a liquid crystal layer and a reflective unit. Wherein, the lower substrate unit is disposed oppositely to the upper substrate unit. The liquid crystal layer is disposed between the upper substrate unit and the lower substrate unit. The reflective unit is disposed at the outside of the lower substrate unit. After an external light passes through the upper substrate unit and the lower substrate unit, the external light is reflected by the reflective unit and generating a diffuse reflection effect. The present invention can save the mask fee, simplify the manufacturing process, avoid the defect and improve the reflection display effect.

### BACKGROUND OF THE INVENTION

1. Field of the Invention

The present invention relates to a display technology field, and more particularly to a display device, a reflective display panel and a reflective unit.

2. Description of Related Art

With reference to FIG. 1, a liquid crystal display panel is generally formed by aligning a color filter substrate (CF substrate) 10 and an array substrate (TFT substrate) 20 together, and a space between the two substrates is packaged with a liquid crystal layer (LC).

Because liquid crystal molecules do not emit light, the display panel requires a light source to display an image. According to different types of light sources, the liquid crystal panel can be divided into a transmissive type, a reflective type and a transflective type.

The reflective type liquid crystal display panel mainly utilizes a front light source or an external light source as the light source. An array substrate of the liquid crystal panel utilizes metal or a reflective electrode having a good reflective property as a reflective region in order to reflect lights of the front light source or the external light source. The advantage of the reflective type liquid crystal display panel is to utilize the external light source so that the power consumption is relatively low.

In the reflective type liquid crystal display panel of the conventional art, in order to make an observer to see an even reflection effect at every viewing angle, a reflective layer 30 has to be designed as a reflection way having diffuse reflection. Therefore, in the conventional art, the reflective layer 30 is designed to have a micro structure having a concave and convex surface in order to realize the diffuse reflection.

The specific manufacturing method is: firstly, forming a layer of resin base on the reflective region. Secondly, using a mask to perform an array process such as exposing, developing and etching on the resin base to form the micro structure having the concave and convex surface. The above manufacturing process requires an additional mask. Finally, sputtering a metal layer (silver or aluminum) on the micro structure having the concave and convex surface as the reflective layer 30.

Accordingly, the conventional art for manufacturing the reflective layer 30 having the micro structure having the concave and convex surface requires an additional mask fee so as to increase the manufacturing cost. Besides, in an actual production, because of the precision limitation for manufacturing the micro structure having the concave and convex surface, a morphological defect is easily to generate so as to affect the diffuse reflection effect. Therefore, a new design is required to solve the above problems.

### SUMMARY OF THE INVENTION

The present invention provides a display device, a reflective display panel and a reflective unit to solve the problems of high cost and bad effect because of forming the micro structure having the concave and convex surface on the resin base using the mask.

In order to solve the above technology problem, a technology solution adopted by the present invention is: a reflective unit, wherein the reflective unit is disposed at an outside of a liquid crystal panel, and after an external light passes through the liquid crystal panel, the external light is reflected by the reflective unit and generating a diffuse reflection effect, and the reflective unit includes: a scattering layer disposed at the outside of the liquid crystal panel; and a metal layer attached to the scattering layer; wherein, the scattering layer is used to realize the diffuse reflection effect, and a surface of the metal layer is a flat plane without any concave and convex micro structure, and used for forming a specular reflection.

In order to solve the above technology problem, another technology solution adopted by the present invention is: a reflective display panel, comprising: an upper substrate unit; a lower substrate unit disposed oppositely to the upper substrate unit; a liquid crystal layer disposed between the upper substrate unit and the lower substrate unit; and a reflective unit disposed at an outside of the lower substrate unit, and after an external light passes through the upper substrate unit and the lower substrate unit, the external light is reflected by the reflective unit and generating a diffuse reflection effect.

According to a preferred embodiment, the reflective unit includes a scattering layer disposed at the outside of the lower substrate unit and a metal layer attached to the scattering layer, wherein, the scattering layer is used to realize the diffuse reflection effect, and a surface of the metal layer is a flat plane without any concave and convex micro structure, and used for forming a specular reflection.

According to a preferred embodiment, the scattering layer is a transparent film, and the transparent film is provided with scattering particles.

According to a preferred embodiment, the transparent film is a polyethylene terephthalate (PET) film, a polyethylene (PE) film or a polyvinyl chloride (PVC) film.

According to a preferred embodiment, the metal layer is aluminum or silver, and the metal layer is coated on a surface of the scattering layer.

In order to solve the above technology problem, another technology solution adopted by the present invention is: a display device including a back frame module and a reflective display panel, the back frame module is used for installing the reflective display panel, and the reflective display panel includes: an upper substrate unit; a lower substrate unit disposed oppositely to the upper substrate unit; a liquid crystal layer disposed between the upper substrate unit and the lower substrate unit; and a reflective unit disposed at an outside of the lower substrate unit, and after an external light passes through the upper substrate unit and the lower substrate unit, the external light is reflected by the reflective unit and generating a diffuse reflection effect.

The beneficial effects of the present invention are: different from the prior art, the reflective display panel 100 provided by the present invention does not require a mask for forming the micro structure having the concave and convex surface. The present invention utilizes a joint action of the metal layer and the scattering layer disposed at the outside of the lower substrate unit to generate the diffuse reflection effect so that the observer can see an even reflection effect at every viewing angle. Comparing with the conventional art, the present invention can save the mask fee, simplify the manufacturing process, avoid the defect and improve the reflection display effect.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic structure diagram of a reflective display panel according to the conventional art;

FIG. 2 is a schematic structure diagram of a reflective display panel according to a preferred embodiment of the present invention; and

FIG. 3 is a schematic structure diagram of a display device according to a preferred embodiment of the present invention.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

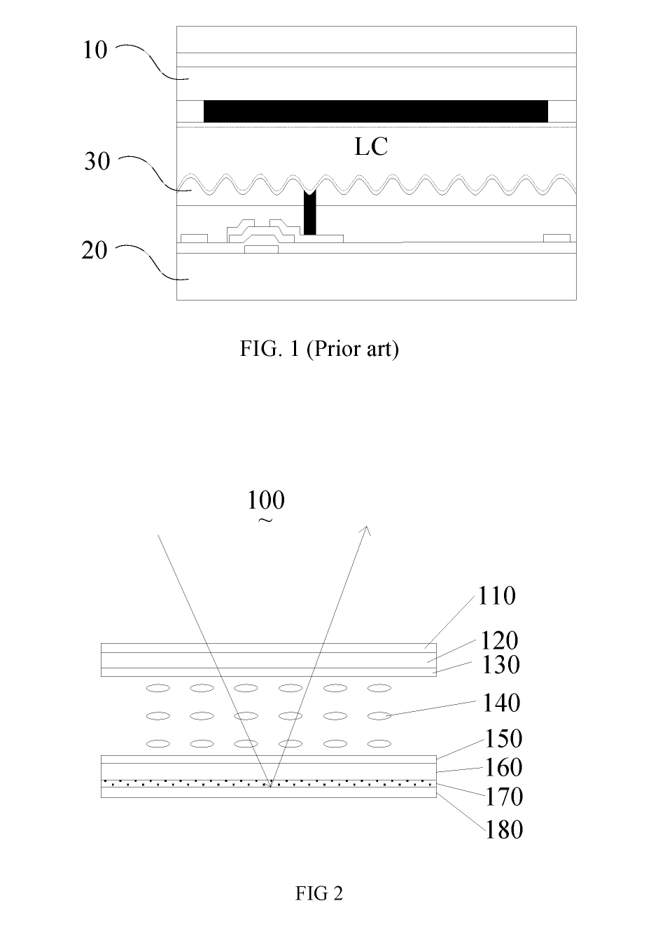

With reference to FIG. 2, and FIG. 2 is a schematic structure diagram of a reflective display panel according to a preferred embodiment of the present invention.

As shown in FIG. 2, the present invention provides a reflective display panel 100 including an upper substrate unit, a lower substrate unit, a liquid crystal layer 140 and a reflective unit stacked from top to bottom.

Wherein, the upper substrate unit includes a color filter polarizer 110, a color filter substrate 120 and a common electrode 130 stacked from top to bottom. The color filter polarizer 110 only can make a light having a certain of vibrating direction to pass through, and block (absorb) a light vibrated in the other vibrating direction. The color filter substrate 120 includes a glass substrate and a RGB three-primary color layer arranged on the glass substrate as a matrix. The common electrode 130 is a surface electrode. Preferably, an indium tin oxide (ITO) film having properties of transparent, excellent conductivity, etching property and good reliability can be utilized for the common electrode 130.

The lower substrate unit is disposed oppositely to the upper substrate unit. The lower substrate unit includes a pixel electrode 150 and a thin film transistor (TFT) substrate 160 stacked from top to bottom. The pixel electrode 150 is a rectangular electrode utilizing a transparent, excellent conductivity, etching property and good reliability ITO film at the same time. The TFT substrate 160 is manufacturing by multiple photolithography processes.

The liquid crystal layer 140 includes multiple liquid crystal molecules, and the liquid crystal molecules are injected between the upper substrate unit and the lower substrate unit through a vacuum injection method or a one drop filling (ODF) method. After injecting the liquid crystal material is finished, utilizing an ultraviolet curing type sealant to seal an injection hole.

A size of the reflective unit is identical or similar as a size of the lower substrate unit, and the reflective unit is disposed at an outside of the lower substrate unit. After an external light passes through the upper substrate unit and the lower substrate unit, the external light is reflected by the reflective unit and generating a diffuse reflection effect.

Specifically, the reflective unit includes a scattering layer 170 and a metal layer 180, and sizes of the scattering layer 170 and the metal layer 180 are identical or similar The scattering layer 170 is aligned with the lower substrate unit and disposed at the outside of the lower substrate unit. The metal layer 180 is attached to the scattering layer 170. The scattering layer 170 is used to realize the diffuse reflection effect. A surface of the metal layer 180 is a flat plane without any concave and convex micro structure for forming the specular reflection.

In a specific embodiment, the scattering layer 170 is a transparent film, and the transparent film is evenly provided with scattering particles. The transparent film can be a polyethylene terephthalate (PET) film, a polyethylene (PE) film or a Polyvinyl Chloride (PVC) film The metal layer 180 can be aluminum or silver, and the metal layer 180 is disposed on a surface of the scattering layer 170 through a coating method.

Besides, the present invention also provides a reflective unit. With reference to FIG. 2, the reflective unit is disposed at an outside of the liquid crystal panel formed by the upper substrate unit, the lower substrate unit and the liquid crystal layer 140. After an external light passes through the liquid crystal panel, the external light is reflected by the reflective unit and a diffuse reflection effect is generated. The reflective unit includes a scattering layer 170 and a metal layer 180. Sizes of the scattering layer 170 and the metal layer 180 are identical or similar. The scattering layer 170 is aligned with the lower substrate unit and disposed at the outside of the lower substrate unit. The metal layer 180 is attached to the scattering layer 170. The scattering layer 170 is used to realize the diffuse reflection effect. A surface of the metal layer 180 is a flat plane without any concave and convex micro structure for forming the specular reflection. The specific structure of the scattering layer 170 and the metal layer 180 is the same as the reflective display panel 100 as described above, no more repeating.

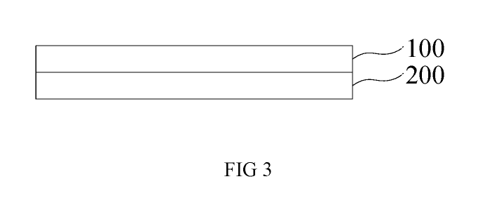

With reference to FIG. 3, and FIG. 3 is a schematic structure diagram of a display device according to a preferred embodiment of the present invention.

The present invention also provides a display device. The display device includes a back frame module 200 and the reflective display panel 100 described above. The back frame module 200 is an integrated type or a segmented type for installing the reflective display panel 100.

The upper substrate unit, the lower substrate unit, the back frame module 200 and other necessary parts in the present invention can refer to the conventional art, no more repeating.

In summary, the person skilled in the art can understand that the reflective display panel 100 provided by the present invention does not require a mask for forming the micro structure having the concave and convex surface. The present invention utilizes a joint action of the metal layer 180 and the scattering layer 170 disposed at the outside of the lower substrate unit to generate the diffuse reflection effect so that the observer can see an even reflection effect at every viewing angle. Comparing with the conventional art, the present invention can save the mask fee, simplify the manufacturing process, avoid the defect and improve the reflection display effect.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A reflective unit, wherein the reflective unit is disposed at an outside of a liquid crystal panel, and after an external light passes through the liquid crystal panel, the external light is reflected by the reflective unit and generating a diffuse reflection effect, and the reflective unit includes:
a scattering layer disposed at the outside of the liquid crystal panel; and
a metal layer attached to the scattering layer;
wherein, the scattering layer is used to realize the diffuse reflection effect, and a surface of the metal layer is a flat plane without any concave and convex micro structure, and used for forming a specular reflection.

2. The reflective unit according to claim 1, wherein, the scattering layer is a transparent film, and the transparent film is provided with scattering particles.

3. The reflective unit according to claim 2, wherein, the transparent film is a polyethylene terephthalate (PET) film, a polyethylene (PE) film or a polyvinyl chloride (PVC) film.

4. The reflective unit according to claim 3, wherein, the metal layer is aluminum or silver, and the metal layer is coated on a surface of the scattering layer.

5. A reflective display panel, comprising:
an upper substrate unit;
a lower substrate unit disposed oppositely to the upper substrate unit;
a liquid crystal layer disposed between the upper substrate unit and the lower substrate unit; and
a reflective unit disposed at an outside of the lower substrate unit, and after an external light passes through the upper substrate unit and the lower substrate unit, the external light is reflected by the reflective unit and generating a diffuse reflection effect.

6. The reflective display panel according to claim 5, wherein the reflective unit includes a scattering layer disposed at the outside of the lower substrate unit and a metal layer attached to the scattering layer, wherein, the scattering layer is used to realize the diffuse reflection effect, and a surface of the metal layer is a flat plane without any concave and convex micro structure, and used for forming a specular reflection.

7. The reflective display panel according to claim 6, wherein the scattering layer is a transparent film, and the transparent film is provided with scattering particles.

8. The reflective display panel according to claim 7, wherein, the transparent film is a polyethylene terephthalate (PET) film, a polyethylene (PE) film or a polyvinyl chloride (PVC) film.

9. The reflective display panel according to claim 8, wherein, the metal layer is aluminum or silver, and the metal layer is coated on a surface of the scattering layer.

10. A display device including a back frame module and a reflective display panel, the back frame module is used for installing the reflective display panel, and the reflective display panel includes:
an upper substrate unit;
a lower substrate unit disposed oppositely to the upper substrate unit;
a liquid crystal layer disposed between the upper substrate unit and the lower substrate unit; and
a reflective unit disposed at an outside of the lower substrate unit, and after an external light passes through the upper substrate unit and the lower substrate unit, the external light is reflected by the reflective unit and generating a diffuse reflection effect.

11. The display device according to claim 10, wherein the reflective unit includes a scattering layer disposed the outside of the lower substrate unit and a metal layer attached to the scattering layer, wherein, the scattering layer is used to realize the diffuse reflection effect, and a surface of the metal layer is a flat plane without any concave and convex micro structure, and used for forming a specular reflection.

12. The display device according to claim 11, wherein the scattering layer is a transparent film, and the transparent film is provided with scattering particles.

13. The display device according to claim 12, wherein the transparent film is a polyethylene terephthalate (PET) film, a polyethylene (PE) film or a polyvinyl chloride (PVC) film.

14. The display device according to claim 13, wherein the metal layer is aluminum or silver, and the metal layer is coated on a surface of the scattering layer.
